(19) United States
(12) Patent Application Publication
(10) Pub. No.: US 2025/0383840 A1
(43) Pub. Date: Dec. 18, 2025

(54) MERGE-SORT LLM PROMPTING FOR DATA ANALYTICS

(71) Applicant: Navan, Inc., Palo Alto, CA (US)

(72) Inventor: Ilan Ezra Twig, San Francisco, CA (US)

(21) Appl. No.: 19/238,139

(22) Filed: Jun. 13, 2025

Related U.S. Application Data
(60) Provisional application No. 63/659,600, filed on Jun. 13, 2024.

(51) Int. Cl. G06F 7/16; G06F 16/242; G06F 16/2455

(52) U.S. Cl. CPC G06F 7/16; G06F 16/2428; G06F 16/24566

(57) ABSTRACT

An online system enables large language models (LLMs) to perform analytics on large datasets that exceed the LLM's context window by employing a recursive merge-sort prompting approach. Upon receiving a free-text analysis request from a user, the system generates an initialization prompt for the LLM to create a merge prompt template. The dataset is recursively divided into portions, which may be equal or semantically segmented subsets, and each portion is analyzed by the LLM. If a portion still exceeds the context window, the recursive process continues on its subsets. Outputs from each analysis are merged using a merge prompt template, which may include fields for outputs, data, and descriptions of subsets. The merge prompt template is used to generate a merge prompt, which is provided to the LLM to synthesize a final response.

### CROSS REFERENCE TO RELATED APPLICATIONS

This application claims the benefit of U.S. Provisional Patent Application Ser. No. 63/659,600, filed Jun. 13, 2024, which is incorporated by reference.

### BACKGROUND

An online system may store data on behalf of a third-party entity in a database as part of providing a service to the third-party entity. The third-party entity may want analytics to be performed on their data and provided to them as part of the service by the online system. For example, the online system may provide a support chat function and may allow a third-party entity to request analytics to be performed on their data through the support chat function.

Certain basic analysis can be performed through a simple mapping of a user's request to generic analytical processes the online system can perform. However, a third-party entity may request analytics that go beyond ones that the online system is configured to automatically perform. For example, the third-party entity may request that analytics be performed that are specific to the third-party entity's data. In these situations, the online system may either not respond to the entity's request or may have a human operator perform the analytics. The former option provides an unsatisfactory experience to the entity and the latter may require a lot of human labor and time to perform.

### SUMMARY

An online system uses a merge sort approach to prompting an LLM with a large data set to avoid the limitations that come with the limited context windows of LLMs. The online system receives an analysis request from a user to perform an analysis on the large data set. For example, the analysis request may be to compute certain metrics based on the data set. The online system generates an analysis prompt template based on the analysis request from the user. The analysis prompt is a prompt template for prompts that request that an LLM respond to the analysis request from the user based on data included with an analysis prompt generated based on the prompt template.

The online system starts the recursive merge-sort process by determining whether a terminating condition is met. For example, the online system determines whether the set of data passed to the recursive process would exceed the context window of the LLM when included with the analysis prompt. The terminating condition may be met when the size of the analysis prompt with the set of data would be within the context window and is not met when the size would exceed the context window. If the terminating condition is met, the online system generates an analysis prompt based on the passed set of data and the analysis prompt template. The online system transmits the analysis prompt to the LLM and the LLM generates a response with the analysis requested by the analysis request.

If the terminating condition is not met, the online system applies the recursive process to subsets of the set of data. For example, the online system may split the set of data in half and apply the recursive process to each half. The recursive process is continued with each half until the terminating condition is met (e.g., until the process has continued to split the set of data such that each split section fits within the context window of the LLM) and the recursive process on each half returns an output from its application to each half. The online system applies a merge prompt template to the output from each half. A merge prompt template is a template for generating a merge prompt, which is a prompt for the LLM to generate a response for the analysis request based on the output of the recursive process as applied to each portion of the set of data. The merge prompt includes the output from each application of the recursive process and free text instructions for the LLM to generate a response that merges the outputs into a single output. The merge prompt template may include the free text instructions and fields for where the outputs of the recursive process may be inserted into the template to generate the merge prompt. The online system may generate the merge prompt template by prompting an LLM to generate the merge prompt template based on the analysis request.

The online system iteratively applies the recursive process to subsets of the set of data and applies the merge prompt template to the outputs of those processes until the online system has processed all of the data in the initial set of data. The online system returns the output of the recursive processes to the user as a response to the analysis prompt.

The described process represents an improvement in the technical field of large language model (LLM) data analytics by enabling LLMs to analyze datasets that exceed their inherent context window limitations. By recursively partitioning data and using a merge-sort prompting strategy, the system allows for scalable and efficient processing of large or complex datasets that would otherwise be infeasible for direct LLM analysis. The use of merge prompt templates to synthesize outputs from multiple subsets further enhances the system's ability to generate comprehensive and contextually accurate responses. This approach not only extends the practical capabilities of LLMs but also automates and streamlines the workflow for users, supporting advanced analytics applications such as policy compliance and expense management in a manner that was previously unattainable with conventional LLM prompting techniques

### DETAILED DESCRIPTION

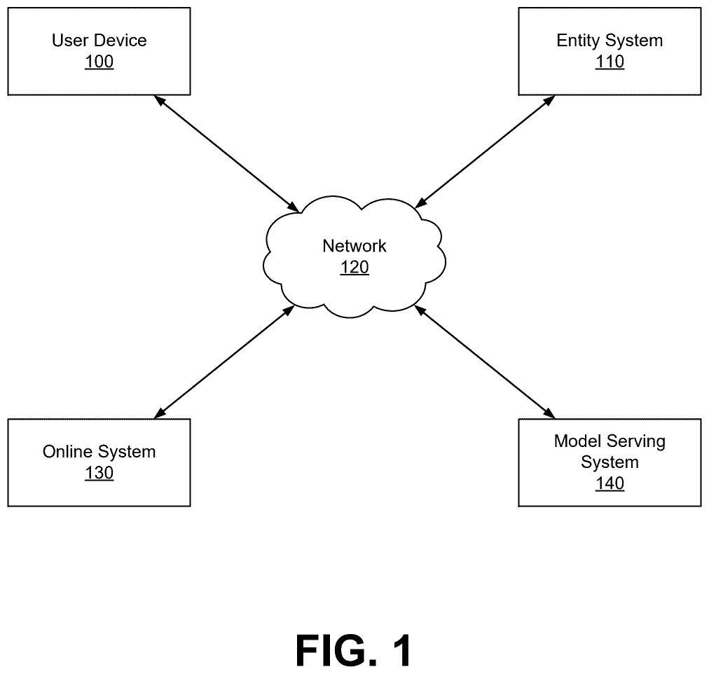

FIG. 1 is illustrates an example system environment for an online system, in accordance with some embodiments.

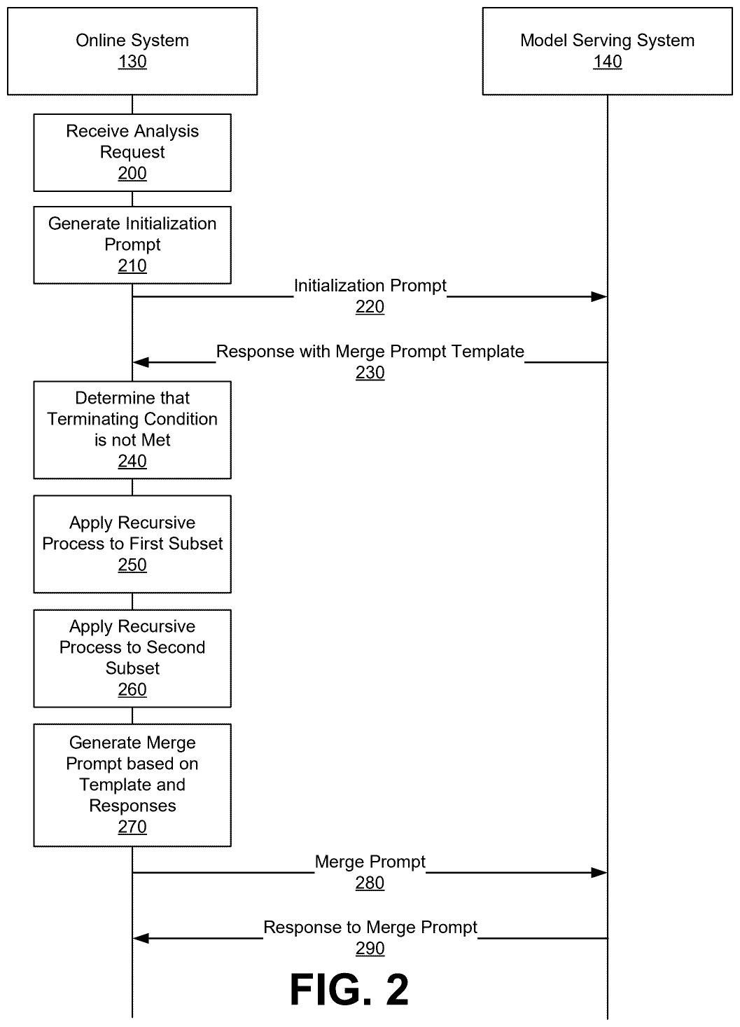

FIG. 2 is an interaction diagram for an example method for applying a merge-sort approach to LLM prompting for improved data analytics, in accordance with some embodiments.

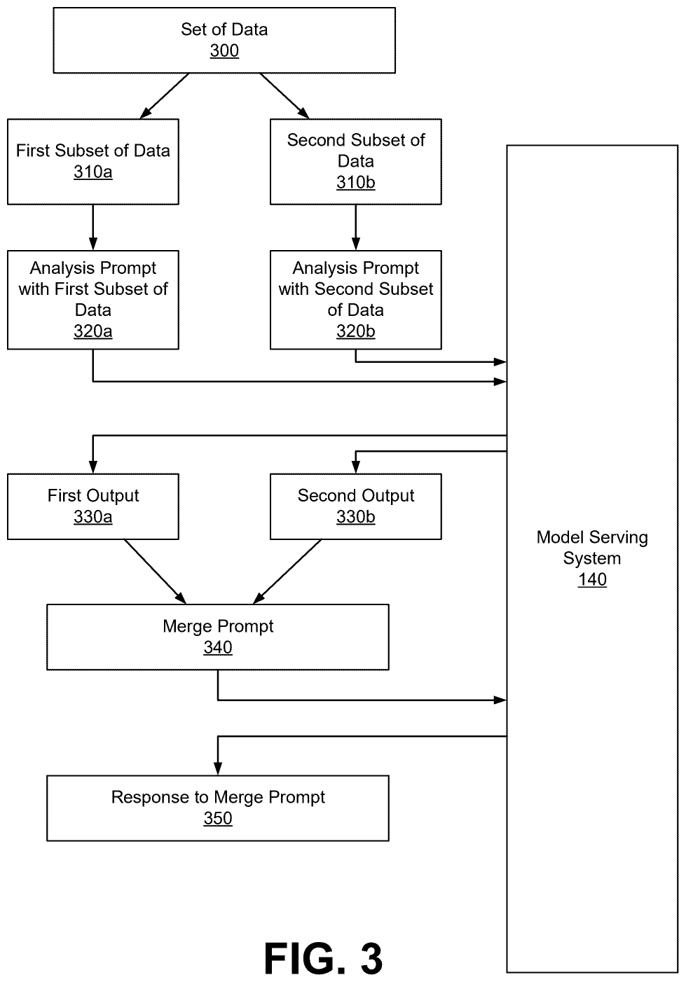

FIG. 3 is an example data flow illustrating a step in the recursive process, in accordance with some embodiments.

### DETAILED DESCRIPTION

### System Environment

FIG. 1 illustrates an example system environment for an online system 130, in accordance with some embodiments. The system environment illustrated in FIG. 1 includes a user device 100, an entity system 110, a network 120, an online system 130, and a model serving system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

A user can interact with other systems through a user device 100. The user device 100 can be a personal or mobile computing device, such as a smartphone, a tablet, a laptop computer, or desktop computer. In some embodiments, the user device 100 executes a client application that uses an application programming interface (API) to communicate with other systems through the network 120.

Though the system can be applied in many environments, in one example, the system is applied for expense management, and specifically associated with expense policies and corporate credit card usage. In this example, the user corresponding to the user device 100 may be assigned a corporate credit card by the entity corresponding to the entity system 110. The corporate credit card is a credit card that is issued to the user associated with the entity or that is issued to the entity to be used by the user. For example, the user may be an employee of the entity (e.g., a corporation, company, or organization) and the user may use the credit card to purchase goods and services on behalf of the entity. However, the entity may have one or more expense policies that restrict or define specific parameters around the goods or services that the user can purchase using the card. For example, the expense policy may limit from which merchants the user may purchase goods or services, when the user may use the credit card, or in which geographic locations or areas the user may use the credit card. The expense policy for an entity may be managed and enforced by the online system 130, as described in further detail below.

The user device 100 receives policy results for the user's transactions that were processed by the online system 130. These policy results indicate whether the user's transaction was covered by the entity's expense policy. These results can be received in real-time or near real-time. For example, the user device 100 can be notified on a mobile application or via another notification mechanism at the point of sale (e.g., during or after the user has swiped the credit card at the merchant) certain details about the transactions. For example, the user may be notified that the transaction has been approved or denied, the notification may specify certain details around the policy that will be violated by the transaction (e.g., the transaction will exceed the policy limit for that particular type of purchase or that type of merchant). In some embodiments, the transaction proceeds even if it violates an expense policy. If the user's transaction proceeded but was not covered by the entity's expense policy, the policy results may further indicate that the user must reimburse the entity for the transaction. In other embodiments, the transaction is blocked or prevented based on the violation of the entity's expense policy. In this example, the user may receive a notification as to why the transaction is not going through, and may modify the transaction (e.g., reduce the amount being spent such that it falls under an expense policy limit, or purchase a different item that falls under the policy requirements, etc.). More details about the dynamically applied policies are included below.

The entity system 110 is a computing system operated by an entity. The entity may be a business, organization, or government, and the user may be an agent or employee of the entity.

In embodiments where the online system 130 serves as an expense management system, the entity system 110 entity system 110 provides an interface to other employees of the entity (e.g., expense administrators, accounts team members, etc.) to specify expense policies for the user's corporate credit card, and transmits the expense policies to the online system 130. The entity system 110 also may receive policy results from the online system 130 that indicate whether a user's transaction is covered by the expense policies set by the entity. These policy results can be presented in an interface to, for example, expense administrators or accounts team members that manage adherence to those policies. These policy results may also indicate whether the entity system 110 is reimbursed by the user or whether the entity system 110 reimburses the user. While the entity system 110 is primarily described herein as being separate from the online system 130, the entity system 110 may perform some or all of the functionality of the online system 130. In some embodiments, the online system 130 is provided by another party, and the entity subscribes to the online system 130 through that other party so that the entity is able to use the system 130 to dynamically manage its expenses. In other embodiments, another party may provide software that the entity can purchase or use to provide the online system 130 functionality within the entity system 110.

The network 120 is a collection of computing devices that communicate via wired or wireless connections. The network 120 may include one or more local area networks (LANs) or one or more wide area networks (WANs). The network 120, as referred to herein, is an inclusive term that may refer to any or all of standard layers used to describe a physical or virtual network, such as the physical layer, the data link layer, the network layer, the transport layer, the session layer, the presentation layer, and the application layer. The network 120 may include physical media for communicating data from one computing device to another computing device, such as MPLS lines, fiber optic cables, cellular connections (e.g., 3G, 4G, or 5G spectra), or satellites. The network 120 also may use networking protocols, such as TCP/IP, HTTP, SSH, SMS, or FTP, to transmit data between computing devices. In some embodiments, the network 120 may include Bluetooth or near-field communication (NFC) technologies or protocols for local communications between computing devices. Similarly, the network 120 may use phone lines for communications. The network 120 may transmit encrypted or unencrypted data.

The online system 130 stores information for entities in databases. The online system 130 may have a database for each entity and may store transaction information for the entity in their corresponding database. The online system 130 also may provide a support chat interface through which a user corresponding to an entity can request information on the entity's data stored by the online system 130. For example, the user device 100 may present a chat interface from the online system 130 to the user and the user may use the chat interface to request information from the online system 130. The online system 130 automatically provides answers to the user's request. Example methods for answering a user's request for information are described in further detail below with regards to FIGS. 2 and 3.

In some embodiments, the online system 130 is an expense management system. An expense management system is a computing system that manages expenses incurred for an entity by users. The expense management system receives expense policies from the entity system 110, which constrain or define limits or parameters around the transactions that a user may expense to the entity using their corporate credit card from the entity. For example, the expense policies may include a per diem, a lodging budget, a rail travel budget, a flight budget, limitations on merchants or merchant categories at which the credit card can be used, or limitations on geographic regions or locations in which the card can be used. The expense management system receives transaction information describing a transaction and determines whether the transaction described by the transaction information complies with the expense policies from the entity system 110. The expense management system transmits policy results to the user through the user device 100 and to the entity through the entity system 110. These results indicate whether a transaction complies with the expense policies of the entity. If the transaction does not comply with the expense policy, the expense management system may approve or reject the transaction, ask for additional information about the transaction (e.g., request that the user take a photo of a receipt for the transaction, request that the user provide a note describing the transaction or a purpose of the transaction, request that the user identify other users that were associated with the transaction), transmit a request to the user device 100 for the user to reimburse the entity for the transaction, allow the user to contest the approval or rejection, only provide a partial reimbursement, among other possibilities.

The model serving system 140 receives requests from other systems to perform tasks using machine-learned models. The tasks include, but are not limited to, natural language processing (NLP) tasks, audio processing tasks, image processing tasks, video processing tasks, and the like. In one embodiment, the machine-learned models deployed by the model serving system 140 are models configured to perform one or more NLP tasks. The NLP tasks include, but are not limited to, text generation, query processing, machine translation, chatbots, and the like. In one embodiment, the language model is configured as a transformer neural network architecture. Specifically, the transformer model is coupled to receive sequential data tokenized into a sequence of input tokens and generates a sequence of output tokens depending on the task to be performed.

The model serving system 140 receives a request including input data (e.g., text data, audio data, image data, or video data) and encodes the input data into a set of input tokens. The model serving system 140 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens may be arranged as a tensor with one or more dimensions, for example, one dimension, two dimensions, or three dimensions. In an example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one embodiment, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 130 or one or more entities different from the online system 130. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one embodiment, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

### Example Method for Merge-Sort LLM Prompting for Data Analytics

FIG. 2 is an interaction diagram for an example method for applying a merge-sort approach to LLM prompting for improved data analytics, in accordance with some embodiments. Alternative embodiments may include more, fewer, or different steps from those illustrated in FIG. 2 and the steps may be performed in a different order or by different devices than those illustrated in FIG. 2.

The online system receives 200 an analysis request from a user. The analysis request is natural language text describing a request for analytics from the online system based on a set of data stored by the online system. For example, the analysis request may request that the online system identify trends in user behavior on the online system or potentially identify malicious behavior of users based on user interaction data or application workflow outputs. The online system receives the analysis request through a user interface displayed on the user's client device. For example, the user interface may include a chatbot interface whereby the user can input prompts to a chatbot and responses from the chatbot are displayed to the user. The online system may receive the analysis request as a prompt input by the user to the chatbot interface. In some embodiments, the user interface further includes UI elements whereby the user can input parameters for the recursive prompting of the model serving system.

The online system begins a merge-sort analytical process by generating 210 an initialization prompt 220 for an LLM of the model serving system. An initialization prompt is a prompt for the LLM that requests that the LLM generate a merge prompt template for the analysis request. The merge prompt template is a template that the online system can use to generate merge prompts. These merge prompts are prompts for the LLM to merge the output of a recursive process applied to different subsets of the set of data. For example, a merge prompt may include the output of subprocesses and instructions for the LLM to use the outputs of the subprocesses to generate an output. In some embodiments, the initialization prompt includes the analysis request from the user and instructs the LLM to generate a prompt to respond to the analysis request. The initialization prompt may further include the set of data to which the analysis request should be applied or a description of the set of data.

The online system transmits the initialization prompt 220 to the model serving system and receives a response 230 from the model serving system with the merge prompt template. The initialization prompt may include instructions on how the LLM should generate the response, and the online system extracts the merge prompt template from the response.

The online system may being the recursive analysis process by determining whether a terminating condition is met. A terminating condition is a condition which, if it exists, indicates that the recursive analysis should terminate or not begin. For example, the online system may determine whether the set of data is smaller than a context window of the model serving system's LLM or may determine whether the set of data meets other criteria based on how the LLM performs on prompts of different sizes or types.

If the terminating condition is met (e.g., the set of data is smaller than the context window), the online system may simply use the model serving system to generate an output based on the analysis request and the set of data. For example, the model serving system may generate an analysis prompt based on the natural language text in the analysis request and prompt the LLM to generate output based on the analysis request. The analysis prompt may further include the set of data to be analyzed.

However, if the online system determines 240 that the terminating condition is not met, the online system applies 250 the recursive process to the set of data. The online system splits the set of data into subsets and applies the recursive process for each of the subsets. For example, the online system may identify a first subset and second subset of the set of data (e.g., two halves of the set of data) and applies the recursive process to each of the subsets. The online system may determine how many subsets to generate and which portions of the set of data should be included in each subset. For example, the online system may simply split the set of data into equal portions. Alternatively, the online system may semantically segment the data based on subject matter or other metadata and split the set of data based on semantic segmentation.

The recursive process continues for each of the subsets of data by, as described above, determining whether a terminating condition is met for each of the subsets. If the terminating condition is met for a subset of the set of data, the online system generates an analysis prompt based on the subset of data and inputs the prompt to the LLM to generate an output for that subset of data. However, if the terminating condition is not met for the subset of data, the online system continues the recursive process on that subset of data as well. The online system continues the recursive process on each of the subsets until an output is generated for each of the subsets.

The online system generates 270 a merge prompt based on the outputs generated for each of the subsets of data. The merge prompt includes the outputs generated for the subsets of data and instructions to use the generated outputs to generate a response to the user's analysis request. The online system generates instructions for the merge prompt based on the merge prompt template. For example, the merge prompt template may have instructions to be included in the merge prompt. Those instructions may include fields for outputs generated based on subsets of data. The merge prompt template may further include fields for descriptions of the subsets of data on which each output was generated. In some embodiments, the merge prompt template includes fields for some or all of each subset of data.

The online system transmits the merge prompt 280 to the model serving system and receives a response 290 to the merge prompt. The response includes an output for the set of data that was analyzed through the recursive process. If the set of data is the full set of data to be used for the user's analysis request, the online system may display this response 290 as an answer to the analysis request (e.g., in a chat user interface displayed to the user on a client device). However, if the set of data was itself a subset of the full set of data provided or identified by the user (e.g., where the merge prompt was used as part of a recursive subprocess), the online system uses the output in the response to the merge prompt as the output for that subset of data.

FIG. 3 is an example data flow illustrating a step in the recursive process, in accordance with some embodiments. In the data flow illustrated by FIG. 3, the set of data 300 to which the recursive process is applied is too large for the context window of the model serving system's LLM, so the online system splits the set of data into a first 310a and second 310b subset of data. If these subsets of data were still too large, the online system may iteratively generate subsets of data until the subsets are small enough to fit within the context window. The online system generates an analysis prompt 320 based on an analysis request received from a user and each subset of data and transmits those analysis prompts to the model serving system. The online system receives a first 330a and second 330b output from the model serving system corresponding to the first 320a and second 320b analysis prompts, and generates a merge prompt 340 based on those outputs. The online system transmits the merge prompt 340 to the model serving system and receives a response 350 to that merge prompt.

While the above description predominantly describes prompting an LLM directly, in some embodiments, the online system interfaces with an agentic system that uses generative artificial intelligence to generate responses as part of the recursive merge-sort process. For example, the online system may interface with an agentic system that has access to additional functionality, such as online searching, content generation, or physical modeling. Furthermore, an agentic system may use the recursive merge-sort approach itself.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
receiving, at an online system, an analysis request from a user, wherein the analysis request comprises free text requesting analytics of a set of data stored by the online system in a database;
generating an initialization prompt based on the analysis request, wherein the initialization prompt comprises text instructing a large language model to generate a merge prompt template based on the analysis request;
transmitting the initialization prompt to the large language model;
receiving a response to the initialization prompt, wherein the response comprises the merge prompt template;
generating a response to the analysis request by applying a recursive process to the set of data, wherein the recursive process comprises:
determining whether a terminating condition for the recursive process is met;
and
responsive to determining that the terminating condition is not met:
applying the recursive process to a first portion of the set of data to generate a first output, wherein applying the recursive process to the first portion comprises applying the analysis request to the first portion of the set of data using the large language model;
applying the recursive process to a second portion of the set of data to generate a second output, wherein applying the recursive process to the second portion comprises applying the analysis request to the second portion of the set of data using the large language model;
generating a merge prompt based on the merge prompt template, the first output, and the second output;
transmitting the merge prompt to the large language model; and
receiving a response to the merge prompt from the large language model; and
transmitting a response to the analysis request based on the received response to the merge prompt.

2. The method of claim 1, wherein the first portion and the second portion each comprise substantially equal subsets of the set of data.

3. The method of claim 1, wherein the first portion and the second portion each comprise a semantically segmented subset of the set of data.

4. The method of claim 1, wherein receiving the analysis request from the user comprises:
receiving the analysis request through a chat user interface presented on a display of a client device of the user.

5. The method of claim 1, further comprising:
receiving, through a user interface presented to the user on a display of a client device, input parameters for the recursive prompting; and
generating the initialization prompt based on the input parameters.

6. The method of claim 1, wherein the merge prompt template includes fields for outputs generated by applying the recursive process to the first portion and the second portion.

7. The method of claim 6, wherein the merge prompt template includes fields for text descriptions of the first portion and the second portion in association with the corresponding fields for the outputs.

8. The method of claim 1, wherein the merge prompt template includes a field for some or all of the set of data.

9. The method of claim 1, wherein applying the recursive process to the first portion comprises:
determining whether the first portion meets the terminating condition.

10. The method of claim 9, further comprising:
responsive to determining that the first portion does not meet the terminating condition, applying the recursive process to subsets of the first portion.

11. A non-transitory computer-readable medium storing instructions that, when executed by a computer system, cause the computer system to perform operations comprising:
receiving, at an online system, an analysis request from a user, wherein the analysis request comprises free text requesting analytics of a set of data stored by the online system in a database;
generating an initialization prompt based on the analysis request, wherein the initialization prompt comprises text instructing a large language model to generate a merge prompt template based on the analysis request;
transmitting the initialization prompt to the large language model;
receiving a response to the initialization prompt, wherein the response comprises the merge prompt template;
generating a response to the analysis request by applying a recursive process to the set of data, wherein the recursive process comprises:
determining whether a terminating condition for the recursive process is met; and
responsive to determining that the terminating condition is not met:
applying the recursive process to a first portion of the set of data to generate a first output, wherein applying the recursive process to the first portion comprises applying the analysis request to the first portion of the set of data using the large language model;
applying the recursive process to a second portion of the set of data to generate a second output, wherein applying the recursive process to the second portion comprises applying the analysis request to the second portion of the set of data using the large language model;
generating a merge prompt based on the merge prompt template, the first output, and the second output;
transmitting the merge prompt to the large language model; and
receiving a response to the merge prompt from the large language model; and
transmitting a response to the analysis request based on the received response to the merge prompt.

12. The computer-readable medium of claim 11, wherein the first portion and the second portion each comprise substantially equal subsets of the set of data.

13. The computer-readable medium of claim 11, wherein the first portion and the second portion each comprise a semantically segmented subset of the set of data.

14. The computer-readable medium of claim 11, wherein receiving the analysis request from the user comprises:
receiving the analysis request through a chat user interface presented on a display of a client device of the user.

15. The computer-readable medium of claim 11, further comprising:
receiving, through a user interface presented to the user on a display of a client device, input parameters for the recursive prompting; and
generating the initialization prompt based on the input parameters.

16. The computer-readable medium of claim 11, wherein the merge prompt template includes fields for outputs generated by applying the recursive process to the first portion and the second portion.

17. The computer-readable medium of claim 16, wherein the merge prompt template includes fields for text descriptions of the first portion and the second portion in association with the corresponding fields for the outputs.

18. The computer-readable medium of claim 11, wherein the merge prompt template includes a field for some or all of the set of data.

19. The computer-readable medium of claim 11, wherein applying the recursive process to the first portion comprises:
determining whether the first portion meets the terminating condition.

20. The computer-readable medium of claim 19, further comprising:
responsive to determining that the first portion does not meet the terminating condition, applying the recursive process to subsets of the first portion.
